(19) United States
(12) Patent Application Publication
(10) Pub. No.: US 2004/0021556 A1
(43) Pub. Date: Feb. 5, 2004

(54) Apparatus for reporting stealing of automobiles

(76) Inventor: Yasumoto Murooka, Nara-shi (JP)

Correspondence Address: Koda & Androlia, Suite 3850, 2029 Century Park East, Los Angeles, CA, 90067, US

(21) Appl. No.: 10/210,344

(22) Filed: Jul. 31, 2002

(51) Int. Cl. B60R 25/10

(52) U.S. Cl. 340/426.18

(57) ABSTRACT

Apparatus for reporting stealing of automobiles includes a no-move detecting means, a transfer detecting sensor and a radio transmitter. The no-move setting means establishes no-move of an automobile. A transfer detecting sensor detects shift of a position of the automobile after the no-move setting. A radio transmitter reports an occurrence of stealing to a designated place when the transfer detecting sensor detects the shift of the position of the automobile. On an occurrence of stealing, this apparatus automatically reports the fact to the designated place.

### TECHNICAL FIELD OF THE INVENTION

The present invention relates to apparatus for reporting stealing of automobiles which automatically reports an occurrence of stealing of an automobile or vehicle.

### DESCRIPTION OF RELATED ART

Known apparatus for alarming stealing of automobiles is in general made to let a warning buzzer go as a door of an automobile is opened or closed, or to let a warning buzzer go in an occurrence of a jolt or a vibration of an automobile. Accordingly, the occurrence of stealing or burglary is informed to people nearby.

However, in the foregoing apparatus which informs of burglary by an alarm or warning buzzer, the buzzer sound reaches only in a limited range, and there were cases in which no effective measures could be taken in an occurrence of stealing or burglary.

Therefore, there has been a demand, among owners of automobiles, especially those who own luxury cars, for development of apparatus for reporting stealing of automobiles which reports an occurrence of stealing to a designated place automatically when it occurs, and which reports a fact of occurrence of stealing an automobile, the number of the automobile, the place of the stealing to a designated place automatically at that time.

It is hence an object of the present invention to provide apparatus for reporting stealing of automobiles which reports a fact of occurrence of stealing to a designated place automatically when it occurs. It is a further object of the present invention to provide apparatus for reporting stealing of automobiles which reports a fact of occurrence of stealing an automobile, the number of the automobile, the place of the stealing to a designated place automatically at that time.

### SUMMARY OF THE INVENTION

Apparatus for reporting stealing of automobiles or vehicles according to the present invention includes a no-move setting means which establishes no-move setting of an automobile, a transfer detecting means which detects shift of the position of the automobile after the no-move setting on the automobile, and a radio transmitter which reports an occurrence of stealing to a designated place when the transfer detecting means detects the shift or move of the automobile.

Also, a PHS (Personal Handyphone System) terminal may be used as the radio transmitter. The vehicle number and information relating to the location of an automobile itself which is estimated from a nearby key station of the PHS terminal may be reported.

Apparatus for reporting stealing of automobiles according to the present invention includes a no-move setting means which establishes no-move of an automobile, a GPS receiver which detects the location of the automobile itself by receiving radio waves from GPS satellites, and a radio transmitter which reports an occurrence of stealing to a designated place when a location of the automobile itself detected by the GPS receiver changes before and after the establishment of no-move of the automobile.

Apparatus for reporting stealing of automobiles according to the present invention includes a no-move setting means which establishes no-move of an automobile, a transfer detecting means which detects a shift of the position of the automobile after the setting of no-move of the automobile, a GPS receiver which detects a location of the automobile itself by receiving radio waves from GPS satellites, and a radio transmitter which reports an occurrence of stealing to a designated place when the transfer detecting means detects a move of the automobile.

The apparatus for reporting stealing of automobiles according to the present invention may also provide, as a report, the number of the automobile and information relating to the location of the automobile itself which is obtained from the GPS receiver.

Also, the report can be in the form of facsimile telegram, synthesis sound or email.

The apparatus for reporting stealing of automobiles according to the present invention can also include an engine actuating detecting sensor which detects start of an engine. So with the radio transmitter, the apparatus reports a stealing occurrence to a designated place when the engine actuating detecting sensors detects start and/or running of the engine after the no-move setting of the automobile.

The apparatus for reporting stealing of automobiles according to the present invention can furthermore include a sensor which detects destruction of window glass of the automobile, and, with the radio transmitter, the apparatus reports an occurrence of stealing to the designated place when the sensor detects the destruction of the window glass after the establishment of no-move setting of an automobile.

The apparatus for reporting stealing of automobiles according to the present invention can also include another sensor which detects opening of a door or a trunk of the automobile. With the radio transmitter, the apparatus may report to the designated place the occurrence of stealing when the sensor detects the opening of the door or trunk after the establishment of the no-move setting of an automobile.

The above and other objects, features and advantages of the present invention will become apparent from the following description in conjunction with the accompanying drawings.

### BRIEF DESCRIPTION OF THE DRAWING

FIG. 1 is a block diagram of the apparatus reporting stealing or accident of automobiles according to an embodiment of the present invention.

### DETAILED DESCRIPTION OF THE INVENTION

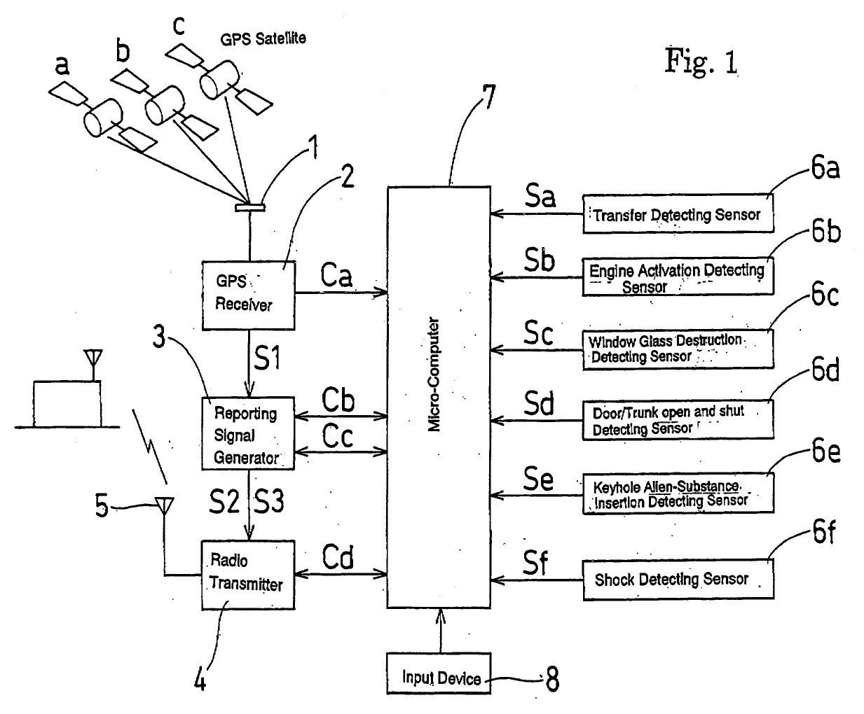

The block diagram of the electrical structure of the apparatus reporting stealing or accident of automobiles according to one of embodiments of the present invention is illustrated in FIG. 1.

This apparatus reporting stealing or accident of automobiles is to be loaded onto an automobile, as in FIG. 1, it includes an antenna 1, a GPS receiver 2, a reporting signal generator 3, a radio transmitter 4, an antenna 5, a transfer detecting sensor 6a, an engine actuating detecting sensor 6b, a window glass destruction detecting sensor 6c, a door/trunk open and shut detecting sensor 6d, a keyhole alien-substance insertion detecting sensor 6e, a shock detecting sensor 6f, a micro-computer 7, and an input device 8.

An antenna 1, as in FIG. 1, receives GPS radio waves from GPS satellites a, b and c, and inputs a signal in response to the received waves into the GPS receiver 2.

The GPS receiver 2, as in FIG. 1, receives the GPS radio waves, calculates and outputs the two dimensional location information S1 in digital signal which indicates the latitudes and longitudes of the receiving location.

The reporting signal generator 3, as in FIG. 1, converts the two dimensional location information S1 from the GPS receiver 2 into facsimile telegram S2, synthesized sound signal S3 or email and outputs it.

The radio transmitter 4 is specifically a mobile phone, which is connected to telephone circuit networks via radio circuits in such a way like cellular method.

The antenna 5 is connected to the radio transmitter 4, as in FIG. 1, and performs radio transmission and reception.

The transfer detecting sensor 6a detects transfer while a car engine is not running, such as when a car being towed away by a wrecker. With no-move setting, when detecting transfer, the sensor 6a outputs a transfer detecting signal Sa, as in FIG. 1.

The engine actuating detecting sensor 6b detects continuous jolt or vibration and/or flow of battery current when the engine is started. When detecting jolt, shake, vibration or the like after the no-move setting, the sensor 6b outputs an engine actuating detecting signal Sb, as in FIG. 1.

The window glass destruction detecting sensor 6c detects air flow inside a car when the window glass is broken. Detecting the air flow after the setting of no-move, the sensor 6c outputs a window glass destruction detecting signal Sc, as in FIG. 1.

The door or trunk open and shut detecting sensor 6d detects opening of the door or the trunk of a car, and outputs the door or trunk open and shut detecting signal Sd, as in FIG. 1, when the door or the trunk is opened after the setting to no-move.

The keyhole alien-substance insertion detecting sensor 6e detects insertion of any substance other than a right key. For example, insertion of an implement for the purpose of breaking the door keyhole, or insertion of a duplicate-key making implement for the purpose of making a duplicate key. The sensor 6e detects insertion of alien substance other than the right key after the no-move setting, and outputs a keyhole alien-substance insertion detecting signal Se, as in FIG. 1.

A shock detecting sensor 6f detects a shock beyond fixed level on the car at the time of the accident occurrence. When such a shock is applied in the course of driving, the sensor 6f detects it and outputs the shock detecting signal Sf, as in FIG. 1.

The micro-computer 7 controls the GPS receiver 2, the reporting signal generator 3 and the radio electrical transmitter 4 through the controlling signal Ca, Cb, Cc and Cd.

The input device 8 establishes the no-move setting for the prevention of the stealing after parking, the setting to automatic report of an accident when starting to drive, and the setting to the form of the report to a designated place; in the form of facsimile telegram, synthesized sound or email. And the device 8 is furnished with a keyboard and the like.

The settings and functions of the apparatus for reporting automobile or vehicle burglary or accident are described as follows:

(1) Setting of the phone number of the reporting destination is established by the radio transmitter 4. The reporting destination may be such places like; an owner of a car, facilities like a police station and a hospital where emergency report can be received, and contracting security companies.

(2) Setting of the form of report (i.e. in the form of facsimile telegraph, synthesized sound or email) is established by the input device 8. Namely, the micro-computer 7 chooses which to take; a facsimile signal generating part, a synthesized sound signal generating part or the like in the reporting signal generator 3, and the control the function.

(3) The input device 8 indicates to establish the setting of report of either the occurrence of burglary or the accident-occurrence. Namely, after parking, the device 8 sets to the no-move setting for prevention of burglary or stealing, and when starting to drive, to the setting of report of accident.

(4) When the above settings (1), (2), (3) have been finished, apparatus becomes in stand-by mode to detect occurrence of stealing or accident-occurrence.

(5) When receiving a transfer detecting signal Sa, an engine actuating detecting signal Sb, a window glass destruction detecting signal Sc, a door/trunk open and shut detecting signal Sd, and/or a keyhole-alien substance insertion detecting signal Se, the apparatus makes a judgment of an occurrence of stealing or burglary, and when receiving a shock detecting signal Sf, it makes a judgment of an accident-occurrence. To the contrary, receiving none of the signals Sb, Sc, Sd, Se and Sf means that there are no occurrence of stealing or an accident .

(6) In case of an occurrence of stealing or an accident, the micro-computer 7 reports it to a controlling part of the radio transmitter 4. The radio transmitter 8, then reports, for example, “stealing occurred, latitudes xxx degrees, longitudes xxx degrees, vehicle number” or “accident occurred, latitudes xxx degrees, longitudes xxx degrees, vehicle number” to the designation established as above (1) by facsimile telegram, synthesized sound or email. The latitudes and longitudes in the reports are obtained from the two dimensional location information which the GPS receiver 2 calculates from the radio waves received from the GPS satellites a, b and c.

According to the above mentioned embodiment, when the transfer detecting sensor 6a detects the transfer of a car, the radio transmitter 4 reports to a pre-designated place the occurrence of stealing or burglary; but the present invention is not limited thereto. Before and after the setting of no-move, when the position of the car detected by the GPS receiver is shifted, occurrence of stealing may be reported to the designated place by the radio transmitter 4.

Also, in the above mentioned embodiment, the arrangements can be made by excluding the GPS receiver 2 and placing a PHS terminal instead of the radio transmitter 4. The report can be made with estimated location information obtained from a nearby key station of the PHS terminal, not with location information from the GPS receiver. Namely, since the PHS terminal constantly makes mutual communication with a nearby key station to obtain information therefrom, the location of the PHS terminal can be estimated from the information from the nearby key station and the information provided by the nearby key station may be utilized. The information of this art is described specifically in “NTT R&D”, Shadanhojin Denki Tsuhin Kyokai (the Telecommunication Association) Vol.44, pp715-786, 1995.

Instead of the above mentioned embodiments, the apparatus can receive GPS radio waves from four GPS satellites, obtain three dimensional information consisting of latitudes, longitudes and altitude of the reception location, and report three dimensional information.

Being constructed as stated above, the present invention can provide the apparatus for reporting stealing of automobiles which, at the time of car stealing, automatically report the fact to a designated place. And the present invention can provide the apparatus which automatically report to the designated place the fact of stealing, the number of the car and the location of the stealing.

What is claimed is:

1. Apparatus for reporting stealing of automobiles comprising:
a no-move setting means which establishes no-move of an automobile;
a transfer detecting means which detects shift of a position of the automobile after establishing no-move of the automobile; and
a radio transmitter which makes a report of a stealing occurrence to a designated place when the transfer detecting means detects the shift.

2. Apparatus according to claim 1, wherein a PHS (Personal Handyphone System) terminal is used as the radio transmitter.

3. Apparatus according to claim 1, further comprising an engine actuating detecting sensor which detects an engine-running state, wherein the radio transmitter makes the report of the stealing occurrence to the designated place when the engine actuating detecting means detects starting of the engine after establishing no-move of the automobile.

4. Apparatus according to claim 2, further comprising an engine actuating detecting sensor which detects an engine-running state, wherein the radio transmitter makes the report of the stealing occurrence to the designated place when the engine actuating detecting means detects running of the engine after establishing no-move of the automobile.

5. Apparatus according to claim 1, further comprising a window glass destruction detecting sensor, wherein the radio transmitter makes the report of the stealing occurrence to a designated place when the window glass destruction detecting sensor detects window glass destruction after establishing no-move of the automobile.

6. Apparatus according to claim 2, further comprising a window glass destruction detecting sensor, wherein the radio transmitter makes the report of the stealing occurrence to a designated place when the window glass destruction detecting sensor detects window glass destruction after establishing no-move of the automobile.

7. Apparatus according to claim 3, further comprising a window glass destruction detecting sensor, wherein the radio transmitter makes the report of the stealing occurrence to a designated place when the window glass destruction detecting sensor detects window glass destruction after establishing no-move of the automobile.

8. Apparatus according to claim 4, further comprising a window glass destruction detecting sensor, wherein the radio transmitter makes the report of the stealing occurrence to a designated place when the window glass destruction detecting sensor detects window glass destruction after establishing no-move of the automobile.

9. Apparatus according to claim 1, further comprising a door/trunk open detecting sensor, wherein the radio transmitter makes the report of the stealing occurrence to a designated place when the door/trunk open detecting sensor detects a door or trunk of the automobile being opened.

10. Apparatus according to claim 2, further comprising a door/trunk open detecting sensor, wherein the radio transmitter makes the report of the stealing occurrence to a designated place when the door/trunk open detecting sensor detects a door or trunk of the automobile being opened.

11. Apparatus according to claim 3, further comprising a door/trunk open detecting sensor, wherein the radio transmitter makes the report of the stealing occurrence to a designated place when the door/trunk open detecting sensor detects a door or trunk of the automobile being opened.

12. Apparatus according to claim 4, further comprising a door/trunk open detecting sensor, wherein the radio transmitter makes the report of the stealing occurrence to a designated place when the door/trunk open detecting sensor detects a door or trunk of the automobile being opened.

13. Apparatus according to claim 5, further comprising a door/trunk open detecting sensor, wherein the radio transmitter makes the report of the stealing occurrence to a designated place when the door/trunk open detecting sensor detects a door or trunk of the automobile being opened.

14. Apparatus according to claim 6, further comprising a door/trunk open detecting sensor, wherein the radio transmitter makes the report of the stealing occurrence to a designated place when the door/trunk open detecting sensor detects a door or trunk of the automobile being opened.

15. Apparatus according to claim 7, further comprising a door/trunk open detecting sensor, wherein the radio transmitter makes the report of the stealing occurrence to a designated place when the door/trunk open detecting sensor detects a door or trunk of the automobile being opened.

16. Apparatus according to claim 8, further comprising a door/trunk open detecting sensor, wherein the radio transmitter makes the report of the stealing occurrence to a designated place when the door/trunk open detecting sensor detects a door or trunk of the automobile being opened.

17. Apparatus according to claim 2, wherein the report includes a number of the automobile, and information of a location of the automobile itself estimated from a nearby key station of the PHS terminal.

18. Apparatus according to claim 17, wherein the report is in a form of one of facsimilel telegram, synthesized sound and email.

19. Apparatus for reporting stealing of automobiles comprising:
a no-move setting means which establishes no-move of an automobile;
a GPS receiver which detects a location of an automobile by receiving radio waves from GPS satellites; and
a radio transmitter which makes a report of a stealing occurrence to a designated place when the GPS receiver detects shift of a position of the automobile before and after establishing no-move of the automobile.

20. Apparatus according to claim 19, further comprising an engine actuating detecting sensor which detects an engine-running state, wherein the radio transmitter makes the report of the stealing occurrence to the designated place when the engine actuating detecting means detects running of the engine after establishing no-move of the automobile.

21. Apparatus according to claim 19, further comprising a window glass destruction detecting sensor, wherein the radio transmitter makes the report of the stealing occurrence to a designated place when the window glass destruction detecting sensor detects window glass destruction after establishing no-move of the automobile.

22. Apparatus according to claim 20, further comprising a window glass destruction detecting sensor, wherein the radio transmitter makes the report of the stealing occurrence to a designated place when the window glass destruction detecting sensor detects window glass destruction after establishing no-move of the automobile.

23. Apparatus according to claim 19, further comprising a door/trunk open detecting sensor, wherein the radio transmitter makes the report of the stealing occurrence to a designated place when the door/trunk open detecting sensor detects a door or trunk of the automobile being opened.

24. Apparatus according to claim 20, further comprising a door/trunk open detecting sensor, wherein the radio transmitter makes the report of the stealing occurrence to a designated place when the door/trunk open detecting sensor detects a door or trunk of the automobile being opened.

25. Apparatus according to claim 21, further comprising a door/trunk open detecting sensor, wherein the radio transmitter makes the report of the stealing occurrence to a designated place when the door/trunk open detecting sensor detects a door or trunk of the automobile being opened.

26. Apparatus according to claim 22, further comprising a door/trunk open detecting sensor, wherein the radio transmitter makes the report of the stealing occurrence to a designated place when the door/trunk open detecting sensor detects a door or trunk of the automobile being opened.

27. Apparatus according to claim 19, wherein the report includes a number of the automobile, and information of a location of the automobile itself estimated from a nearby key station of the PHS terminal.

28. Apparatus according to claim 27, wherein the report is in a form of one of facsimile telegram, synthesized sound and email.

29. Apparatus for reporting stealing of automobiles comprising:
a no-move setting means which establishes no-move of an automobile;
a transfer detecting means which detects shift of the automobile after establishing no-move of the automobile;
a GPS receiver which detects a location of the automobile by receiving radio waves from GPS satellites; and
a radio transmitter which makes a report of a stealing occurrence to a designated place when the transfer detecting means detects the shift of the automobile.

30. Apparatus according to claim 29, further comprising an engine actuating detecting sensor which detects an engine-running state, wherein the radio transmitter makes the report of the stealing occurrence to the designated place when the engine actuating detecting means detects actuation of the engine after establishing no-move of the automobile.

31. Apparatus according to claim 29, further comprising a window glass destruction detecting sensor, wherein the radio transmitter makes the report of the stealing occurrence to a designated place when the window glass destruction detecting sensor detects window glass destruction after establishing no-move of the automobile.

32. Apparatus according to claim 30, further comprising a window glass destruction detecting sensor, wherein the radio transmitter makes the report of the stealing occurrence to a designated place when the window glass destruction detecting sensor detects window glass destruction after establishing no-move of the automobile.

33. Apparatus according to claim 29, further comprising a door/trunk open detecting sensor, wherein the radio transmitter makes the report of the stealing occurrence to a designated place when the door/trunk open detecting sensor detects a door or trunk of the automobile being opened.

34. Apparatus according to claim 30, further comprising a door/trunk open detecting sensor, wherein the radio transmitter makes the report of the stealing occurrence to a designated place when the door/trunk open detecting sensor detects a door or trunk of the automobile being opened.

35. Apparatus according to claim 31, further comprising a door/trunk open detecting sensor, wherein the radio transmitter makes the report of the stealing occurrence to a designated place when the door/trunk open detecting sensor detects a door or trunk of the automobile being opened.

36. Apparatus according to claim 32, further comprising a door/trunk open detecting sensor, wherein the radio transmitter makes the report of the stealing occurrence to a designated place when the door/trunk open detecting sensor detects a door or trunk of the automobile being opened.

37. Apparatus according to claim 29, wherein the report includes a number of the automobile, and information of a location of the automobile itself estimated from a nearby key station of the PHS terminal.

38. Apparatus according to claim 37, wherein the report is in a form of one of facsimile telegram, synthesized sound and email.
